(19) United States
(12) Patent Application Publication
(10) Pub. No.: US 2025/0056437 A1
(43) Pub. Date: Feb. 13, 2025

(54) INDICATION OF TIME SYNCHRONIZATION REFERENCE FOR SIDELINK-BASED TIME DIFFERENCE POSITIONING TECHNIQUE

(71) Applicant: Nokia Technologies Oy, Espoo (FI)

(72) Inventors: Hyun-Su CHA, Naperville, IL (US); Prajwal KESHAVAMURTHY, Munich (DE); Ryan KEATING, Chicago, IL (US)

(21) Appl. No.: 18/797,526

(22) Filed: Aug. 8, 2024

Related U.S. Application Data
(60) Provisional application No. 63/532,115, filed on Aug. 11, 2023.

(51) Int. Cl. H04W 56/00; H04W 64/00; H04W 92/18

(52) U.S. Cl. CPC H04W 56/001; H04W 64/006; H04W 92/18

(57) ABSTRACT

Embodiments of the invention provide at least for receiving information comprising at least one of a priority of a time synchronization reference (SyncRef) for sidelink data communications or a request of using a SyncRef for sidelink positioning; and determining, based on at least the information, the SyncRef for a sidelink positioning reference signal (PRS) transmission timing, a sidelink PRS reception; and performing at least one sidelink positioning measurement for one or more sidelink PRSs or transmitting information of one or more sidelink PRSs based on the determined SyncRef. Further, determining information comprising at least one of a priority of a SyncRef for sidelink data communications or a request of using a SyncRef for sidelink positioning; and sending towards a network device the configuration for performing at least one sidelink positioning measurement for one or more sidelink PRSs or transmitting one or more sidelink PRSs based on a determined SyncRef.

### TECHNICAL FIELD

The teachings in accordance with the exemplary embodiments of this invention relate generally to methods for use in 5G or NR of estimation of a user equipment location at least based on sidelink positioning reference signals, to techniques for wireless communication and, more particularly, to techniques for controlling, for example, the time synchronization for sidelink positioning to improve positioning accuracy performance in a wireless network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
3GPP 3^{rd} Generation Partnership Project
AGC Automatic Gain Control
DU Distributed Unit
CU Centralized Unit
gNB 5G Base Station
GNSS Global Navigation Satellite System
LMF Location Management Function
LPP LTE Positioning Protocol
MAC-CE Medium Access Control-Control Element
PRS Positioning Reference Signal
PSCCH Physical Sidelink Control Channel
PSSCH Physical Sidelink Shared Channel
RRC Radio Resource Control
RTOA Relative Time Of Arrival
Rx Receiver/Receive
SCI Sidelink Control Information
SLPP Sidelink Positioning Protocol
SL Sidelink
SLSS Sidelink Synchronization Signal
S-PSS Sidelink Primary Synchronization Signal
S-SSB Sidelink Synchronization Signal Block
SL-RTOA Sidelink Relative Time Of Arrival
S-SSS Sidelink Secondary Synchronization Signal
TDOA Time Difference Of Arrival
TRP Transmit Receive Point
Tx Transmitter/Transmit
UE User Equipment

Communication systems have developed through various generations and there are several different types of wireless communication systems in use e.g., 4G, 5G, and 6G services, and including cellular and personal communications service (PCS) systems.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning, such as downlink, uplink, or sidelink positioning reference signals (PRS)), and other technical enhancements. These enhancements, as well as the use of higher frequency bands, advances in PRS processes and technology, and high- density deployments for 5G, enable highly accurate 5G-based positioning such as sidelink positioning.

Example embodiments of this invention proposes improved operations for at least sidelink positioning operations referenced above.

### SUMMARY

This section contains examples of possible implementations and is not meant to be limiting.

In another example aspect of the invention, there is an apparatus, such as a user equipment side apparatus, comprising: at least one processor; and at least one non-transitory memory storing instructions, that when executed by the at least one processor, cause the apparatus at least to: receive, from a network node, information comprising at least one of a priority of a time synchronization reference for sidelink data communications or a request of using a time synchronization reference for sidelink positioning; determine, based on at least the information, the time synchronization reference fora sidelink positioning reference signal transmission; and perform at least one sidelink positioning measurement for one or more sidelink positioning reference signals or transmit one or more sidelink positioning reference signals based on the determined time synchronization reference.

In still another example aspect of the invention, there is a method, comprising: receiving, from a network node, information comprising at least one of a priority of a time synchronization reference for sidelink data communications or a request of using a time synchronization reference for sidelink positioning; determining, based on at least the information, the time synchronization reference for a sidelink positioning reference signal transmission; and performing at least one sidelink positioning measurement for one or more sidelink positioning reference signals or transmit information of one or more sidelink positioning reference signals based on the determined time synchronization reference.

A further example embodiment is an apparatus and a method comprising the apparatus and the method of the previous paragraphs, wherein the sidelink positioning comprises at least one of a sidelink positioning reference signal configuration, a sidelink positioning reference signal transmission, or sidelink positioning reference reception, wherein the sidelink positioning is using at least one of performing sidelink positioning measurements, reporting sidelink positioning measurements, or location estimation, wherein the sidelink positioning comprises at least one of a sidelink positioning reference signal configuration, a sidelink positioning reference signal transmission, or sidelink positioning reference signal reception; and wherein the sidelink positioning is using at least one of performing sidelink positioning measurements, reporting sidelink positioning measurements, or location estimation, wherein the at least one sidelink positioning measurement for one or more sidelink positioning reference signals uses a requested time synchronization reference, wherein the at least one non-transitory memory storing instructions is executed by the at least one processor to cause the apparatus at least to: transmit an indication of whether a requested or indicated time synchronization reference has been used or not for the at least one sidelink positioning measurement or transmission of at least one sidelink positioning reference signal, wherein the time synchronization reference refers to an obtained synchronization timing from at least one of a base station (gNB), a global navigation satellite system (GNSS), user equipment, or a sidelink synchronization signal associated with a user equipment, wherein the apparatus comprises an anchor user equipment, a server user equipment, or a target user equipment for positioning, and wherein the information comprises a request to use another user equipment, a sidelink synchronization signal associated with the user equipment, a gNB, or a global navigation satellite system as a synchronization reference to determine at least one of a time reference at least one of a reception time of a sidelink positioning reference signal or a transmission time of the sidelink positioning reference signal of the at least one sidelink positioning reference signal, wherein receiving the information on a request of using a first time synchronization reference for sidelink positioning; determining a second time synchronization reference for sidelink positioning based on the synchronization reference priority for sidelink data communications; performing the sidelink positioning measurements based on the second time synchronization reference, wherein the first time synchronization reference is different than the second time synchronization reference; and computing a time difference between the first time synchronization reference and the second time synchronization reference, wherein compensating for the sidelink positioning measurement based on the time difference between the first time synchronization reference and the second time synchronization reference sidelink positioning measurement; and report the compensated sidelink positioning measurement, wherein the information comprises one of: a request to report the used time synchronization reference for the at least one sidelink positioning measurement or the transmitted one or more sidelink positioning reference signals, or a request to report an indication of whether a requested or indicated time synchronization reference source has been used for a sidelink measurement, wherein the information comprises a sidelink synchronization signal identification of the synchronization reference to monitor for time reference for the at least one sidelink positioning measurement, wherein the information comprises a request to report at least one sidelink positioning measurement based on a time synchronization reference and additional information for the sidelink positioning measurements comprising an indication of whether a requested or indicated time synchronization reference source has been used for a sidelink measurement, wherein there is receiving the information on a request of using GNSS as a time synchronization reference for sidelink positioning; using a gNB as a time synchronization reference based on the synchronization reference priority for sidelink data communications, performing sidelink positioning reference signal measurements based on the gNB as a synchronization reference; and compute a time difference between the GNSS-based time synchronization reference and the gNB-based synchronization reference, wherein there is comparing a timing based on a time synchronization reference priority for sidelink data communications and the requested time synchronization reference for positioning; and based on whether the timing is exceeding a threshold value, determining whether to follow the requested time synchronization reference for the at least one sidelink positioning measurement, wherein there is following the requested synchronization reference for sidelink positioning to determine at least one of a reference reception time or a reference transmission time of the sidelink positioning reference signals and follow a legacy synchronization reference priority for sidelink data communications comprising transmission or reception of physical sidelink control channel or physical sidelink shared channel reference signals, wherein the information comprises an indication to follow a requested time synchronization reference comprises instructions to perform the sidelink positioning measurement within a provided time window, and wherein the information comprises at least one of a length of the window, a periodicity of the window, a starting point of the window, or request to use a time synchronization reference for the at least one sidelink positioning measurements or the transmissions of the sidelink positioning reference signals, and/or wherein based not being able to use the requested synchronization reference resource within the provided time window, report sidelink positioning reference measurements made before a change of a time synchronization reference.

A non-transitory computer-readable medium storing program code, the program code executed by at least one processor to perform at least the method as described in the paragraphs above.

In yet another example aspect of the invention, there is an apparatus comprising: means for receiving, from a network node, information comprising at least one of a priority of a time synchronization reference for sidelink data communications or a request of using a time synchronization reference for sidelink positioning; means for determining, based on at least the information, the time synchronization reference for a sidelink positioning reference signal transmission; and means for performing at least one sidelink positioning measurement for one or more sidelink positioning reference signals or transmit information of one or more sidelink positioning reference signals based on the determined time synchronization reference.

In accordance with the example embodiments as described in the paragraph above, at least the means for receiving, determining and performing comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus at least to: determine, information comprising a configuration comprising at least one of a priority of a time synchronization reference for sidelink data communications or a request of using a time synchronization reference for sidelink positioning; and send towards a user equipment the configuration for use to perform at least one sidelink positioning measurement for one or more sidelink positioning reference signals or transmit one or more sidelink positioning reference signals based on a determined time synchronization reference.

In still another example aspect of the invention, there is a method, comprising: determining, information comprising a configuration comprising at least one of a priority of a time synchronization reference for sidelink data communications or a request of using a time synchronization reference for sidelink positioning; and sending towards a user equipment the configuration for use to perform at least one sidelink positioning measurement for one or more sidelink positioning reference signals or transmit one or more sidelink positioning reference signals based on a determined time synchronization reference.

A further example embodiment is an apparatus and a method comprising the apparatus and the method of the previous paragraphs, wherein the time synchronization reference refers to a synchronization reference, and wherein the apparatus comprises at least one of a base station (gNB), a global navigation satellite system (GNSS), user equipment, or an anchor user equipment, wherein the user equipment comprises an anchor user equipment, a server user equipment, or a target user equipment for positioning, wherein the information comprises a request to use another user equipment, a sidelink synchronization signal associated with the user equipment, a gNB, or a global navigation satellite system as a synchronization reference to determine a time reference at least one of a reception time of a sidelink positioning reference signal or a transmission time of the sidelink positioning reference signal of a sidelink positioning reference signal, wherein the sidelink positioning comprises at least one of a sidelink positioning reference signal configuration, a sidelink positioning reference signal transmission, or sidelink positioning reference reception; and wherein the sidelink positioning is using at least one of performing sidelink positioning measurements, reporting sidelink positioning measurements, or location estimation, wherein the at least one sidelink positioning measurement for one or more sidelink positioning reference signals uses a requested time synchronization reference, wherein the sidelink positioning comprises at least one of a sidelink positioning reference signal configuration, a sidelink positioning reference signal transmission, or sidelink positioning reference signal reception; and wherein the sidelink positioning is using at least one of performing sidelink positioning measurements, reporting sidelink positioning measurements, or location estimation, wherein the at least one non-transitory memory storing instructions is executed by the at least one processor to cause the apparatus at least to: transmit an indication of whether a requested or indicated time synchronization reference has been used or not for the at least one sidelink positioning measurement or transmission of at least one sidelink positioning reference signal, wherein the time synchronization reference refers to an obtained synchronization timing from at least one of a base station (gNB), a global navigation satellite system (GNSS), user equipment, or a sidelink synchronization signal associated with a user equipment, wherein the configuration comprises one of: a request to report the used time synchronization reference for the at least one sidelink positioning measurement or the transmitted one or more sidelink positioning reference signals, or a request to report an indication of whether a requested or indicated time synchronization reference source has been used for a sidelink measurement, wherein the configuration comprises a sidelink synchronization signal identification of the synchronization reference to monitor for time reference for the at least one sidelink positioning measurement, wherein the configuration comprises a request to report timing measurements based on a time synchronization reference and additional information for the at least one sidelink positioning measurement comprising an indication of whether a requested or indicated time synchronization reference source has been used for a sidelink measurement, wherein there is receiving the information on a request of using GNSS as a time synchronization reference for sidelink positioning; using a gNB as a time synchronization reference based on the synchronization reference priority for sidelink data communications, performing sidelink positioning reference signal measurements based on the gNB as a synchronization reference; and computing a time difference between the GNSS-based time synchronization reference and the gNB-based synchronization reference, wherein there is comparing a timing based on a time synchronization reference priority for sidelink data communications and the requested time synchronization reference for positioning; and based on whether the timing is exceeding a threshold value, determine whether to follow the requested time synchronization reference for the at least one sidelink positioning measurement, wherein there is following the requested synchronization reference for sidelink positioning to determine at least one of a reference reception time or a reference transmission time of the sidelink positioning reference signals and follow a legacy synchronization reference priority for sidelink data communications comprising transmission or reception of physical sidelink control channel or physical sidelink shared channel reference signals, wherein the information comprises an indication to follow a requested time synchronization reference comprises instructions to perform the sidelink positioning measurement within a provided time window, and wherein the information comprises at least one of a length of the window, a periodicity of the window, a starting point of the window, or request to use a time synchronization reference for the at least one sidelink positioning measurements or the transmissions of the sidelink positioning reference signal, and/or wherein based not being able to use the requested synchronization reference resource within the provided time window, report sidelink positioning reference measurements made before a change of a time synchronization reference.

In yet another example aspect of the invention, there is an apparatus comprising: means for determining, information comprising a configuration comprising at least one of a priority of a time synchronization reference for sidelink data communications or a request of using a time synchronization reference for sidelink positioning; and means for sending towards a user equipment the configuration for use to perform at least one sidelink positioning measurement for one or more sidelink positioning reference signals or transmit one or more sidelink positioning reference signals based on a determined time synchronization reference.

In accordance with the example embodiments as described in the paragraph above, at least the means for determining and sending comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1A shows an illustrative example of a Sidelink Relative Time Of Arrival;

FIG. 1B shows a Table 1 of priority groups of synchronization reference sources;

FIG. 2 shows a flow chart of operations in accordance with an example embodiment of the invention;

FIG. 3 shows a high level block diagram of various devices used in carrying out various aspects of the invention;

FIG. 4A and FIG. 4B each show a method in accordance with example embodiments of the invention which may be performed by an apparatus; and

FIG. 5 shows an illustrative example of SL-TDOA.

### DETAILED DESCRIPTION

In example embodiments of this invention there is proposed at least a method and apparatus for techniques for wireless communication and, more particularly, to techniques for controlling, for example, the time synchronization for sidelink positioning to improve positioning accuracy performance in a wireless network.

Standards at the time of this invention relate to sidelink positioning as follows:
Specify solutions for support of sidelink positioning (including ranging) in NR systems, including the following:
Specify SL PRS for support of sidelink positioning such that the SL PRS uses a comb-based (full RE mapping pattern is not precluded) frequency domain structure and a pseudorandom-based sequence where the existing sequence of DL-PRS is used as a starting point:
Specify support for SL PRS bandwidths of up to 100 MHz in FRI spectrum,
NOTE: SL PRS transmission in FR2 is not precluded but no FR2 specific aspects will be specified;
Specify measurements to support RTT-type solutions using SL, SL-AoA, and SL-TDOA;
Specify support of resource allocation for SL PRS:
Including resource allocation Scheme 1 and Scheme 2, where Scheme 1 corresponds to a network-centric SL PRS resource allocation and Scheme 2 corresponds to UE autonomous SL PRS resource allocation,
For resource allocation mechanism for SL PRS in Scheme 2:
Study and specify support of sensing-based resource allocation, and/or a random resource selection,
Study and specify solutions for congestion control for SL PRS and/or inter-UE coordination for SL-PRS;
Support resource allocation for shared resource pool with sidelink communication and dedicated resource pool for SL PRS.

NOTE: For SL positioning resource (pre-)configuration in a shared resource pool with sidelink communication, backward compatibility with legacy UEs should be ensured.

Further, in one agreement there is support for at least the following mechanism to mitigate the impact of synchronization errors between anchor UEs for SL-TDOA based measurement:
Exchange of synchronization information of anchor UEs between a UE and LMF or another UE; and
FFS detailed synchronization information, e.g. synchronization source or reference, relative time difference (RTD), synchronization quality information

### SL Synchronization

SL transmissions are organized in frames identified by the direct frame number (DFN). The DFN enables a UE to synchronize its radio frame transmissions according to the SL timing reference. UEs perform SL synchronization to have the same SL timing reference for SL communication among nearby UEs by synchronizing with a reference. There are four sources for synchronization reference (SyncRef): GNSS, NR Cell (gNB), EUTRAN Cell (eNB or gNB), SyncRef UE or UE's own internal clock.

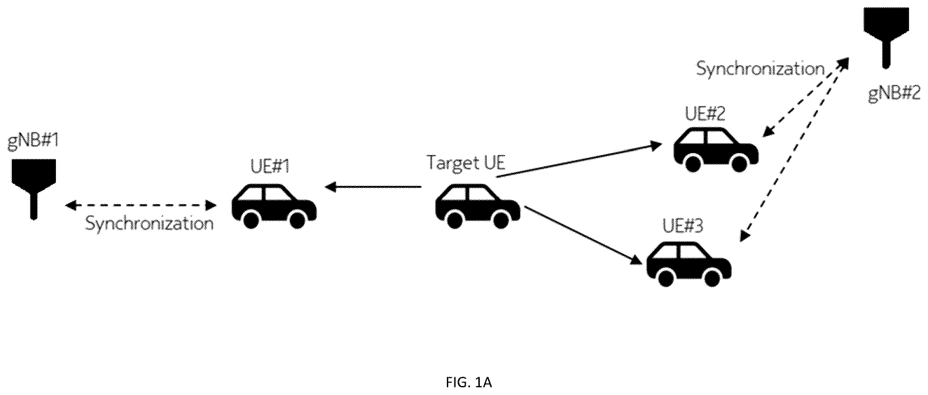

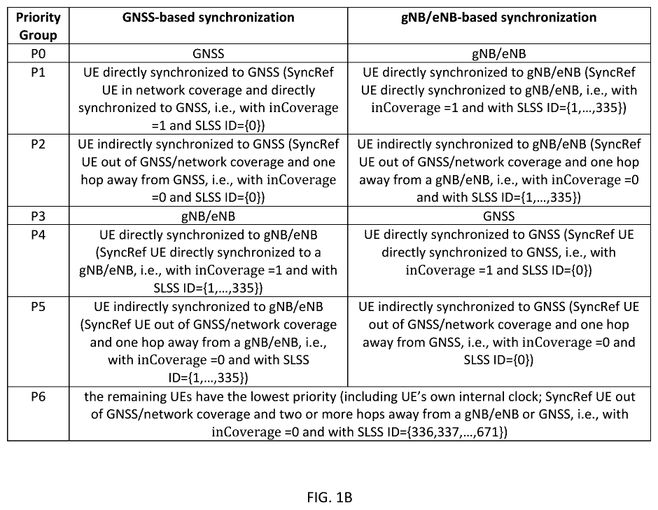

A UE selects its SyncRef summarized in Table 1 of FIG. 1B the different priorities of the sources (where P0 to P6 correspond to highest to lowest priorities, respectively) depending whether it is a GNSS-based synchronization (GNSS as the highest priority) or gNB/eNB-based synchronization (gNB/eNB has the highest priority).

Table 1 as in FIG. 1B shows priority groups of synchronization reference sources.

In standards this prior-art proposes a set of solutions that provides the target UE of a SL positioning session with information about the synchronization accuracy between the anchor UEs to allow for high accuracy positioning. Here, the anchors indicate target UEs the timing reference difference with regards to other anchor UEs.

The table given in Section 3 is the priority of the synchronization source or synchronization reference of the NR sidelink, which is also the prior art. In example embodiments of this invention, the synchronization reference, synchronization source, synchronization reference resource represent the same concept, so there is no difference in this patent application.

FIG. 1A shows an example of SL RTOA (Relative Time of Arrival) technique. A target UE transmits one or multiple SL PRSs, and anchor UEs perform timing measurement such as RTOA. The UE #1 is synchronized to gNB #1 or SyncRef-UE #1 while the synchronization reference (SyncRef) source of UE #2 and UE #3 is gNB #2 or SyncRef-UE #2, as depicted in FIG. 1A. Thus, those three UEs will perform RTOA measurement with a reception reference timing based on their SyncRef source, and they will report the RTOA measurement to a LMF or a server UE. The LMF may calculate differential measurements from the RTOA measurement. But if there would be a time synchronization difference between the different SyncRef sources, it directly impacts SL positioning measurement (i.e., SL RTOA) accuracy. Note that the choice of time SyncRef for SL positioning measurement is more critical than the accuracy of the SyncRef source itself. In this invention, at least this issue is addressed.

Hereafter, is discussed a brief summary on the proposed behavior of LMF and UE including necessary signaling and provide a figure showing overall procedure and signaling.

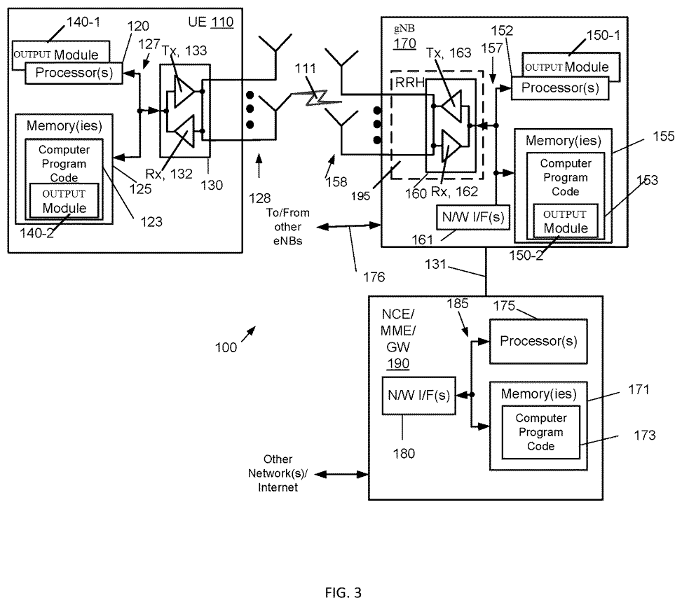

However, before describing the example embodiments as disclosed herein in detail, reference is made to FIG. 3 for illustrating a simplified block diagram of various electronic devices that are suitable for use in practicing the example embodiments of this invention.

FIG. 3 is a block diagram of one possible and non-limiting system in which the example embodiments may be practiced.

Turning to FIG. 3, this figure shows a block diagram of one possible and non-limiting example in which the examples may be practiced. A user equipment (UE) 110, and a radio access LTE, 5G, or 6G network base station i.e., gNB 170, and NCE/MME/GW 190 are illustrated.

In the example of FIG. 3, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a output module 140, comprising one of or both parts 140-1 and/or 140-2, which may be implemented in a number of ways. The output module 140 may be implemented in hardware as output module 140-1, such as being implemented as part of the one or more processors 120. The output module 140-1 may be implemented also as an integrated circuit or through other hardware such as a programmable gate array. In another example, the output module 140 may be implemented as output module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with gNB 170 via a wireless link 111.

The gNB 170 in this example is a base station that provides access by wireless devices such as the UE 110 to the wireless network 100. The gNB 170 may be, for example, a base station for 5G, also called New Radio (NR). In 5G, the gNB 170 may be a NG-RAN node, which is defined as either a gNB or an ng-eNB. A gNB is a node providing NR user plane and control plane protocol terminations towards the UE, and connected via the NG interface to a 5GC (such as, for example, the NCE/MME/GW 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the gNB 170 that controls the operation of one or more gNB-DUs. The gNB-CU terminates the F1 interface connected with the gNB-DU. The F1 interface is illustrated as reference 198, although reference 198 also illustrates a link between remote elements of the gNB 170 and centralized elements of the gNB 170, such as between the gNB-CU 196 and the gNB-DU 195. The gNB-DU is a logical node hosting RLC, MAC and PHY layers of the gNB or gNB 170, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The gNB 170 may also be an eNB (evolved NodeB) base station, for LTE (long term evolution), or any other suitable base station or node.

The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The gNB 170 includes a output module 150, comprising one of or both parts 150-1 and/or 150-2, which may be implemented in a number of ways. The output module 150 may be implemented in hardware as output module 150-1, such as being implemented as part of the one or more processors 152. The output module 150-1 may be implemented also as an integrated circuit or through other hardware such as a programmable gate array. In another example, the output module 150 may be implemented as output module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. Note that the functionality of the output module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 receiver for gNB implementation for 5G, with the other elements of the gNB 170 possibly being physically in a different location from the RRH/DU, and the one or more buses 157 could be implemented in part as, for example, fiber optic cable or other suitable network connection to connect the other elements (e.g., a central unit (CU), gNB-CU) of the gNB 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality. Further, this NCE/MME/GW 190 can for example perform Access & Mobility Management Function (AMF), Location Management Function (LMF), Mobility Management Entity (MME), Network Control Element (NCE), Policy Control Function (PCF), Serving Gateway (SGW), Session Management Function (SMF), and Unified Data Management (UDM). The NCE/MME/GW 190 provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the NCE/MME/GW 190, and note that both 5G and LTE functions might be supported. The gNB 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, NCE/MME/GW 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of output modules 140-1, 140-2, 150-1, and 150-2 may be configured to implement high level syntax for a compressed representation of neural networks based on the examples described herein. Computer program code 173 may also be configured to implement high level syntax for a compressed representation of neural networks based on the examples described herein.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, below is a brief summary on the proposed behavior of LMF and UE including necessary signaling and provide a figure showing overall procedure and signaling.
LMF or server UE requests or indicates UEs (e.g., anchor UEs) to use a specific time synchronization reference (SyncRef) when the UEs report SL positioning timing measurement(s);
The UE is requested by the LMF or server UE to use the specific SyncRef (SyncRef associated with e.g., cell ID, UE ID, SLSS ID, or SyncRef from GNSS, gNB, etc.,) for SL positioning measurement purpose and report the timing measurements based on the requested SyncRef source:
In one embodiment, the UE may comply with the time synchronization priority for SL data communication, but it would be able to report timing measurements based on the requested time SyncRef by calibrating the measurement considering the time difference between two different synchronization references,
In another embodiment, the UE may try to keep two different synchronization reference information (SyncRef) such as the one for legacy SL communication and another one for positioning measurement. That is, to guarantee the positioning measurement accuracy, the UE uses the synchronization reference requested from the LMF,
In the other embodiment, the UE may follow the requested synchronization reference for either a SL PRS Tx timing or a SL PRS Rx timing. For example, if the UE is indicated to report SL-RTOA (Relative Time of Arrival), the UE can use the requested synchronization reference only for the Rx timing for the SL PRS reception. If the UE is requested to report SL-RSTD (Reference Signal Time Difference), the UE can use the requested synchronization reference only for the Tx timing for the SL PRS transmission;

The UE is requested by the LMF to perform SL PRS measurement(s) within a provided/configured window and is requested to use a specific SyncRef source for SL positioning measurement. The UE is not expected to change the SyncRef source within the configured window.

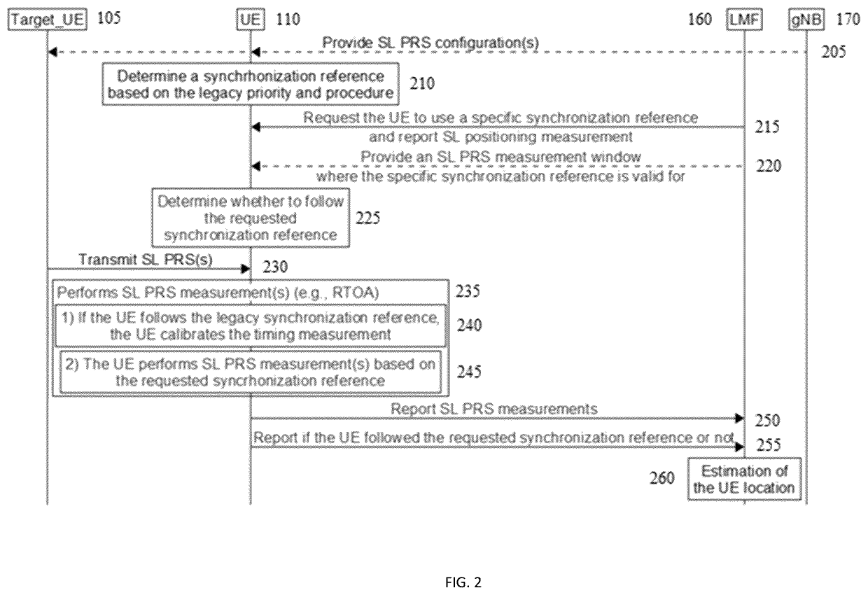

FIG. 2 shows a flow chart showing the overall procedure and signaling in accordance with certain example embodiments of this invention. In this FIG. 2, the UE could be an anchor UE and the LMF could be a network entity or server UE that calculate the location of the target UE.

As shown in FIG. 2 there is signalling between a target UE 105 (such as the UE 110 or the gNB 170 as in FIG. 3), a UE 110 (such as the UE 110 as in FIG. 3), an LMF 160 (such as the UE 110 or gNB 170 as in FIG. 3), and a gNB 170 (such as the gNB 170 as in FIG. 3). As shown in step 205 of FIG. 2 there is signalling between the gNB 170 and the UE 1105 and UE 110 to provide SL PRS configurations. As shown in step 210 of FIG. 2 there is at the UE 110 determining a synchronization reference based on the legacy priority and procedure. As shown in step 215 of FIG. 2 there is between the LMF 160 and the UE 110 a request the UE to use a specific synchronization reference. As shown in step 220 of FIG. 2 there is between the LMF 160 and the UE 110 an indication to provide an SL PRS measurement window where the specific synchronization reference is valid. As shown in step 225 of FIG. 2 the UE 110 determines whether to follow the requested synchronization reference. As shown in step 230 of FIG. 2 there is communication between the target UE 105 and the UE 110 an SL PRS transmission. As shown in step 235 of FIG. 2 the UE 110 performs SL PRS measurement(s) (e.g., RTOA). As shown in step 240 of FIG. 2 the UE 110 follows the legacy synchronization reference an the UE calibrates the timing measurement. As shown in step 245 of FIG. 2 the UE 110 performs SL PRS measurement(s) based on the requested synchronization reference. As shown in step 250 of FIG. 2 there is communicated between the UE 110 and the LMF 160 an SL PRS measurements report. As shown in step 255 of FIG. 2 there is communicated between the UE 110 and the LMF 160 an a report if the UE followed the requested synchronization reference or not. Then as shown in step 260 of FIG. 2 the LMF 160 performs an estimation of the UE location.

This section provides the detailed steps as shown in FIG. 2 in accordance with example embodiments of the invention:
LMF provides the UE with the assistance data for positioning including DL PRS and/or SL PRS configurations. (Prior art);
LMF or server UE requests or indicates UEs (e.g., anchor UEs) to use a specific time synchronization reference (SyncRef) when the UEs report SL positioning timing measurement(s):
In one embodiment, a specific time SyncRef refers to SyncRef from a specific SyncRef source e.g. gNB, GNSS, UE (e.g., SyncRef UE, Target UE, and/or Anchor UE),
In one embodiment, the LMF or server UE requests anchor UEs to use another UE (i.e., SyncRef UE, target, and/or anchor UE) as a SyncRef source to determine a time reference reception time of SL PRS reception, and requests the UEs to report timing measurement (e.g., RTOA) based on a time SyncRef source:
In a further embodiment, the request message to the anchor UEs contains SLSS ID of the SyncRef (i.e. SyncRef UE) that anchors can monitor for timing reference for the measurement:
In one embodiment, a server UE requests an anchor and/or target UE to use the server UE as a synchronization source or synchronization reference (e.g., server UE is acting as a SyncRef UE) to determine a reference time of transmission and reception of SL PRS. In this case, server UE provides its SLSS ID to the anchor UEs;
In another embodiment, LMF or server UE requests the UEs to report timing measurement (e.g., RTOA) based on a time synchronization source or synchronization reference and additional information on the measurement along with the measurement; and
The additional information at least includes whether the requested/indicated time SyncRef source has been used or not for SL positioning measurement (e.g. SL RTOA).

In accordance with example embodiments of the invention the UE is requested by the LMF or server UE to use the specific SyncRef (SyncRef associated with e.g., cell ID, UE ID, SLSS ID, or SyncRef from GNSS, gNB, etc.,) for SL positioning measurement purpose and report the timing measurements based on the requested SyncRef source. That is, the UE may comply with the time synchronization priority for SL data communication, but it would be able to report timing measurements based on the requested time SyncRef.

For example, the UE is requested to report timing measurement(s) with a gNSS as a SyncRef source, but the UE may use a cellular network signal (e.g., cell ID) as a time SyncRef source based on the priority for SL data communication, and it performs SL PRS measurement(s) based on a gNB as a SyncRef source. However, the UE can also check the timing information of GNSS and can compute the time difference between the two SyncRef sources. The UE performs timing measurements (e.g., Rx-Tx time difference) based on the cell ID as a SyncRef source and calibrates the timing measurements based on the time difference between the two SyncRef sources when it reports.

In another example in accordance with example embodiments of the invention, the UE may try to keep two different synchronization reference information (SyncRef) such as the one for legacy SL communication and another one for positioning measurement.

If the timing between two synchronization references is over a threshold value, the UE is not expected to keep two different synchronization references. The UE follows the synchronization reference for the sidelink data communications and report that it has not followed the synchronization reference for positioning measurement requested from the LMF.

In one embodiment in accordance with example embodiments of the invention, If the UE is requested/indicated to report SL-RTOA measurement(s), the UE may follow the requested synchronization reference to determine SL PRS reception timing only and follow the synchronization reference for SL communication to determine SL PRS transmission timing.

The UE is requested by the LMF to perform SL PRS measurement(s) within a provided/configured window and is requested to use a specific SyncRef source for SL positioning measurement. The UE is not expected to change the SyncRef source within the configured window.

The LMF (or server UE) may try to obtain SL TDOA measurement(s) from a target UE with respect to multiple UEs (e.g., anchor UEs) as illustrated in FIG. 3. To obtain the measurement within an aligned timeline between multiple UEs, the LMF may request the UEs to perform measurement within a configured measurement window. The requested synchronization source or synchronization reference may be (UE #ID, SL PRS Resource #ID), (UE #ID, S-SSB #ID), or UE #ID.

If the UE cannot keep using the requested SyncRef source within the window, the UE should report the SL PRS measurement(s) made before the synchronization source or synchronization reference change.

In case the window is periodic or multiple SL PRS transmission occasions are within a window, the UE may or may not be able to keep using the requested synchronization source or synchronization reference. If the UE cannot keep using the requested synchronization source or synchronization reference across multiple occasions, the UE reports the SL PRS measurements, which was made with the requested synchronization source or synchronization reference, and window occasion information on the obtained measurements.

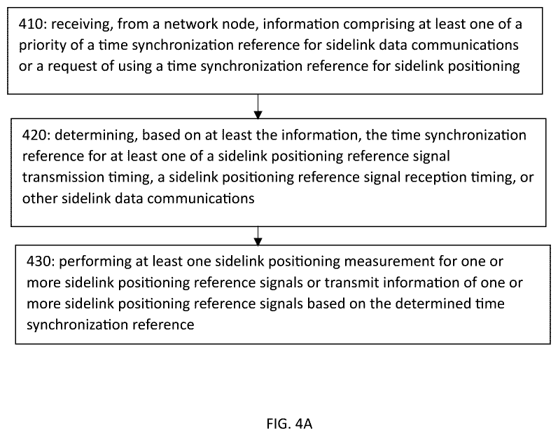

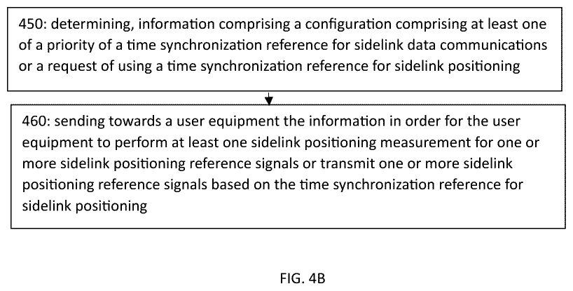

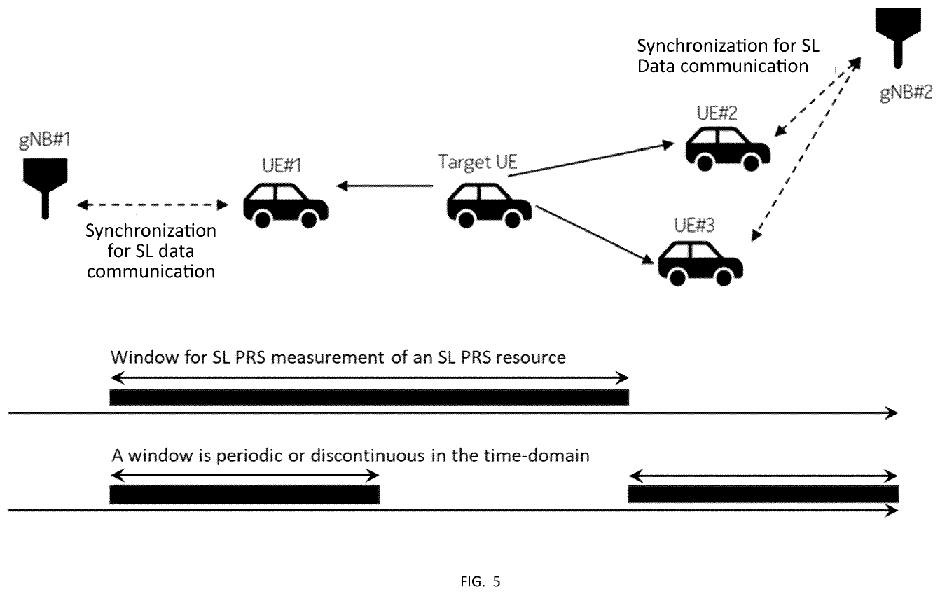

FIG. 4A and FIG. 4B each show a method in accordance with example embodiments of the invention which may be performed by an apparatus.

FIG. 4A illustrates operations which may be performed by a device such as, but not limited to, a device such as a network device (e.g., the UE 110 as in FIG. 3). As shown in block 410 of FIG. 4A there is receiving, from a network node, information comprising at least one of a priority of a time synchronization reference for sidelink data communications or a request of using a time synchronization reference for sidelink positioning. As shown in block 420 of FIG. 4A there is determining, based on at least the information, the time synchronization reference for a sidelink positioning reference signal transmission. Then as shown in block 430 of FIG. 4B there is performing at least one sidelink positioning measurement for one or more sidelink positioning reference signals or transmit information of one or more sidelink positioning reference signals based on the determined time synchronization reference.

In accordance with the example embodiments as described in the paragraph above, wherein the sidelink positioning comprises at least one of a sidelink positioning reference signal configuration, a sidelink positioning reference signal transmission, or sidelink positioning reference signal reception; and wherein the sidelink positioning is using at least one of performing sidelink positioning measurements, reporting sidelink positioning measurements, or location estimation.

In accordance with the example embodiments as described in the paragraphs above, wherein the sidelink positioning comprises at least one of a sidelink positioning reference signal configuration, a sidelink positioning reference signal transmission, or sidelink positioning reference reception; and wherein the sidelink positioning is using at least one of performing sidelink positioning measurements, reporting sidelink positioning measurements, or location estimation. The apparatus of claim 1, wherein the at least one sidelink positioning measurement for one or more sidelink positioning reference signals uses a requested time synchronization reference.

In accordance with the example embodiments as described in the paragraphs above, wherein the at least one non-transitory memory storing instructions is executed by the at least one processor to cause the apparatus at least to: transmit an indication of whether a requested or indicated time synchronization reference has been used or not for the at least one sidelink positioning measurement or transmission of at least one sidelink positioning reference signal.

In accordance with the example embodiments as described in the paragraphs above, wherein the time synchronization reference refers to an obtained synchronization timing from at least one of a base station (gNB), a global navigation satellite system (GNSS), user equipment, or a sidelink synchronization signal associated with a user equipment.

In accordance with the example embodiments as described in the paragraphs above, wherein the apparatus comprises an anchor user equipment, a server user equipment, or a target user equipment for positioning, and wherein the information comprises a request to use another user equipment, a sidelink synchronization signal associated with the user equipment, a gNB, or a global navigation satellite system as a synchronization reference to determine at least one of a time reference of reception time or a time reference of transmission time of the at least one sidelink positioning reference signal.

In accordance with the example embodiments as described in the paragraphs above, wherein receiving the information on a request of using a first time synchronization reference for sidelink positioning; determining a second time synchronization reference for sidelink positioning based on the synchronization reference priority for sidelink data communications; performing the sidelink positioning measurements based on the second time synchronization reference, wherein the first time synchronization reference is different than the second time synchronization reference; and computing a time difference between the first time synchronization reference and the second time synchronization reference.

In accordance with the example embodiments as described in the paragraphs above, wherein there is compensating for the sidelink positioning measurement based on the time difference between the first time synchronization reference and the second time synchronization reference sidelink positioning measurement; and reporting the compensated sidelink positioning measurement.

In accordance with the example embodiments as described in the paragraphs above, wherein the information comprises one of: a request to report the used time synchronization reference for the at least one sidelink positioning measurement or the transmitted one or more sidelink positioning reference signals, or a request to report an indication of whether a requested or indicated time synchronization reference source has been used for a sidelink measurement.

In accordance with the example embodiments as described in the paragraphs above, wherein the information comprises a sidelink synchronization signal identification of the synchronization reference to monitor for time reference for the at least one sidelink positioning measurement.

In accordance with the example embodiments as described in the paragraphs above, wherein the information comprises a request to report timing measurements based on a time synchronization reference and additional information for the at least one sidelink positioning measurement comprising an indication of whether a requested or indicated time synchronization reference source has been used for a sidelink measurement.

In accordance with the example embodiments as described in the paragraphs above, wherein there is receiving the information on a request of using GNSS as a time synchronization reference for sidelink positioning; using a gNB as a time synchronization reference based on the synchronization reference priority for sidelink data communications; performing sidelink positioning reference signal measurements based on the gNB as a synchronization reference; and computing a time difference between the GNSS-based time synchronization reference and the gNB-based synchronization reference.

In accordance with the example embodiments as described in the paragraphs above, wherein there is comparing a timing based on a time synchronization reference priority for sidelink data communications and the requested time synchronization reference for positioning; and based on whether the timing is exceeding a threshold value, determine whether to follow the requested time synchronization reference for the at least one sidelink positioning measurement.

In accordance with the example embodiments as described in the paragraphs above, wherein there is following the requested synchronization reference for sidelink positioning to determine at least one of a reference reception time or a reference transmission time of the sidelink positioning reference signals and follow a legacy synchronization reference priority for sidelink data communications comprising transmission or reception of physical sidelink control channel or physical sidelink shared channel reference signals. The LMF may requests the UEs to use a specific time synchronization reference for sidelink positioning but the UEs may not follow the request as the UE already has to follow the currently defined priority rule on the time synchronization reference for sidelink data communication. The UE may make the sidelink positioning measurements such as SL-RTOA, SL-TDOA, and/or UE Rx-Tx time difference using the time synchronization reference intended for SL communication, and the UE may compensate for the sidelink positioning measurements based on time difference between two different time synchronization sources. The UE will report the compensated measurements to the LMF as the UE is requested to use a time synchronization reference for sidelink positioning.

In accordance with the example embodiments as described in the paragraphs above, wherein the information comprises an indication to follow a requested time synchronization reference comprises instructions to perform the sidelink positioning measurement within a provided time window, and wherein the information comprises at least one of a length of the window, a periodicity of the window, a starting point of the window, or request to use a time synchronization reference for the at least one sidelink positioning measurements or the transmissions of the sidelink positioning reference signal.

In accordance with the example embodiments as described in the paragraphs above, wherein based not being able to use the requested synchronization reference resource within the provided time window, report sidelink positioning reference measurements made before a change of a time synchronization reference.

A non-transitory computer-readable medium (Memory (ies) 125 as in FIG. 3) storing program code (computer program code 123 and/or output module 140-2 as in FIG. 3), the program code executed by at least one processor (Processor(s) 120 and/or output module 140-1 as in FIG. 3) to perform the operations as at least described in the paragraphs above.

In accordance with an example embodiment of the invention as described above there is an apparatus comprising: means for receiving (one or more transceivers 130, Memory (ies) 125, computer program code 123 and/or output module 140-2, and at least one processor (Processor(s) 120 and/or output module 140-1 as in FIG. 3), from a network node (gNB 170 as in FIG. 3), at least one of a priority of a time synchronization reference for sidelink data communications or information on a request of using a time synchronization reference for sidelink positioning; means for determining (one or more transceivers 130, Memory (ies) 125, computer program code 123 and/or output module 140-2, and at least one processor (Processor(s) 120 and/or output module 140-1 as in FIG. 3), based on at least the information, means for the time synchronization reference to perform (one or more transceivers 130, Memory (ies) 125, computer program code 123 and/or output module 140-2, and at least one processor

(Processor(s) 120 and/or output module 140-1 as in FIG. 3) at least one of a sidelink positioning reference signal transmission timing, a sidelink positioning reference signal reception timing, or other sidelink data communications; and means for performing (one or more transceivers 130, Memory (ies) 125, computer program code 123 and/or output module 140-2, and at least one processor (Processor(s) 120 and/or output module 140-1 as in FIG. 3) a timing measurement for one or more sidelink positioning reference signals or transmit information of one or more sidelink positioning reference signals based on the determined time synchronization reference.

In the example aspect of the invention according to the paragraph above, wherein at least the means for receiving, determining, and performing comprises Memory (ies) 125 embodied on computer program code 123 and/or output module 140-2, and executed by at least one processor and/or module (Processor(s) 120 and/or output module 140-1) as in FIG. 4.

FIG. 4B illustrates operations which may be performed by a device such as, but not limited to, a device such as network node (e.g., the gNB 170 as in FIG. 3). As shown in block 450 of FIG. 4B there is determining, information comprising a configuration comprising at least one of a priority of a time synchronization reference for sidelink data communications or a request of using a time synchronization reference for sidelink positioning. Then as shown in block 460 of FIG. 4B there is sending towards a user equipment the information in order for the user equipment to perform at least one sidelink positioning measurement for one or more sidelink positioning reference signals or transmit one or more sidelink positioning reference signals based on the time synchronization reference for sidelink positioning.

In accordance with the example embodiments as described in the paragraph above, wherein the time synchronization reference refers to a synchronization reference, and wherein the apparatus comprises at least one of a base station (gNB), a global navigation satellite system (GNSS), user equipment, or an anchor user equipment.

In accordance with the example embodiments as described in the paragraphs above, wherein the user equipment comprises an anchor user equipment, a server user equipment, or a target user equipment for positioning.

In accordance with the example embodiments as described in the paragraphs above, wherein the information comprises a request to use another user equipment, a sidelink synchronization signal associated with the user equipment, a gNB, or a global navigation satellite system as a synchronization reference to determine a time reference at least one of a reception time of a sidelink positioning reference signal or a transmission time of the sidelink positioning reference signal of a sidelink positioning reference signal.

In accordance with the example embodiments as described in the paragraphs above, wherein the sidelink positioning comprises at least one of a sidelink positioning reference signal configuration, a sidelink positioning reference signal transmission, or sidelink positioning reference reception; and wherein the sidelink positioning is using at least one of performing sidelink positioning measurements, reporting sidelink positioning measurements, or location estimation.

In accordance with the example embodiments as described in the paragraphs above, wherein the at least one sidelink positioning measurement for one or more sidelink positioning reference signals uses a requested time synchronization reference.

In accordance with the example embodiments as described in the paragraphs above, wherein the at least one non-transitory memory storing instructions is executed by the at least one processor to cause the apparatus at least to: transmit an indication of whether a requested or indicated time synchronization reference has been used or not for the at least one sidelink positioning measurement or transmission of at least one sidelink positioning reference signal.

In accordance with the example embodiments as described in the paragraphs above, wherein the time synchronization reference refers to an obtained synchronization timing from at least one of a base station (gNB), a global navigation satellite system (GNSS), user equipment, or a sidelink synchronization signal associated with a user equipment.

In accordance with the example embodiments as described in the paragraphs above, wherein the configuration comprises one of: a request to report the used time synchronization reference for the at least one sidelink positioning measurement or the transmitted one or more sidelink positioning reference signals, or a request to report an indication of whether a requested or indicated time synchronization reference source has been used for a sidelink measurement.

In accordance with the example embodiments as described in the paragraphs above, wherein the configuration comprises a sidelink synchronization signal identification of the synchronization reference to monitor for time reference for the at least one sidelink positioning measurement.

In accordance with the example embodiments as described in the paragraphs above, wherein the configuration comprises a request to report timing measurements based on a time synchronization reference and additional information for the at least one sidelink positioning measurement comprising an indication of whether a requested or indicated time synchronization reference source has been used for a sidelink measurement.

In accordance with the example embodiments as described in the paragraphs above, wherein there is receiving the information on a request of using GNSS as a time synchronization reference for sidelink positioning; using a gNB as a time synchronization reference based on the synchronization reference priority for sidelink data communications, performing sidelink positioning reference signal measurements based on the gNB as a synchronization reference; and computing a time difference between the GNSS-based time synchronization reference and the gNB-based synchronization reference.

In accordance with the example embodiments as described in the paragraphs above, wherein there is comparing a timing based on a time synchronization reference priority for sidelink data communications and the requested time synchronization reference for positioning; and based on whether the timing is exceeding a threshold value, determine whether to follow the requested time synchronization reference for the at least one sidelink positioning measurement.

In accordance with the example embodiments as described in the paragraphs above, wherein there is following the requested synchronization reference for sidelink positioning to determine at least one of a reference reception time or a reference transmission time of the sidelink positioning reference signals and follow a legacy synchronization reference priority for sidelink data communications comprising transmission or reception of physical sidelink control channel or physical sidelink shared channel reference signals.

In accordance with the example embodiments as described in the paragraphs above, wherein the information comprises an indication to follow a requested time synchronization reference comprises instructions to perform the sidelink positioning measurement within a provided time window, and wherein the information comprises at least one of a length of the window, a periodicity of the window, a starting point of the window, or request to use a time synchronization reference for the at least one sidelink positioning measurements or the transmissions of the sidelink positioning reference signal.

In accordance with the example embodiments as described in the paragraphs above, wherein based not being able to use the requested synchronization reference resource within the provided time window, report sidelink positioning reference measurements made before a change of a time synchronization reference.

A non-transitory computer-readable medium (Memory (ies) 155 as in FIG. 3) storing program code (computer program code 153 and/or output module 150-2 as in FIG. 3), the program code executed by at least one processor (Processor(s) 152 and/or output module 150-1 as in FIG. 3) to perform the operations as at least described in the paragraphs above.

In accordance with an example embodiment of the invention as described above there is an apparatus comprising: means for determining (one or more transceivers 160, Memory (ies) 155, computer program code 153 and/or output module 150-2, and at least one processor (Processor(s) 152 and/or output module 150-1 as in

FIG. 3), information comprising a configuration comprising at least one of a priority of a time synchronization reference for sidelink data communications or information on a request of using a time synchronization reference for sidelink positioning; and means for sending (one or more transceivers 160, Memory (ies) 155, computer program code 153 and/or output module 150-2, and at least one processor (Processor(s) 152 and/or output module 150-1 as in FIG. 3) towards a user equipment (UE 110 as in FIG. 3) the information for use to perform at least one sidelink positioning measurement for one or more sidelink positioning reference signals or transmit one or more sidelink positioning reference signals based on the time synchronization reference for sidelink positioning.

Advantages in accordance with example embodiments of the invention include at least:
Improved positioning performance; and
Avoidance of UE behavior which is not intended by network.

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory (ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, a user equipment, a base station, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. An apparatus, comprising:
at least one processor; and
at least one non-transitory memory storing instructions, that when executed by the at least one processor, cause the apparatus at least to:
receive, from a network node, information comprising at least one of a priority of a time synchronization reference for sidelink data communications or a request of using a time synchronization reference for sidelink positioning; and
determine, based on at least the information, the time synchronization reference for at least one of a sidelink positioning reference signal transmission timing, a sidelink positioning reference signal reception timing, or other sidelink data communications; and
perform at least one sidelink positioning measurement for one or more sidelink positioning reference signals or transmit one or more sidelink positioning reference signals based on the determined time synchronization reference.

2.-31. (canceled)
